(19) United States
(12) Patent Application Publication
(10) Pub. No.: US 2023/0162570 A1
(43) Pub. Date: May 25, 2023

(54) GAMING MACHINE AND METHOD WITH SYMBOL CONVERSION FEATURE

(71) Applicant: SG Gaming, Inc., Las Vegas, NV (US)

(72) Inventor: Kimberly COHN, Las Vegas, NV (US)

(21) Appl. No.: 17/534,516

(22) Filed: Nov. 24, 2021

(51) Int. Cl. G07F 17/32; G07F 17/34

(52) U.S. Cl. CPC G07F 17/3267; G07F 17/3213; G07F 17/34

(57) ABSTRACT

There is provided a gaming system, gaming machine, and method that utilize an electronic display device configured to display a plurality of symbol-bearing reels and an array. The reels bear standard symbols, transformable symbols, and a catalyst symbol. Based on a wager tier to which a player's wager belongs, one or more of the transformable symbols are transformed into value-bearing symbols or the catalyst symbol. The reels are then spun and stopped to land symbols in the array. In response to the landed symbols including a catalyst symbol, a payout is awarded based upon values on any value-bearing symbols among the landed symbols.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2021, SG Gaming, Inc.

### FIELD OF THE INVENTION

The present invention relates to a technological improvement to gaming systems, gaming machines, and methods and, more particularly, to new and improved animations in connection with a symbol conversion feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming system, gaming machine, and method that utilize an electronic display device configured to display a plurality of symbol-bearing reels and an array. The reels bear standard symbols, transformable symbols, and a catalyst symbol. Based on a wager tier to which a player's wager belongs, one or more of the transformable symbols are transformed into value-bearing symbols or the catalyst symbol. The reels are then spun and stopped to land symbols in the array. In response to the landed symbols including a catalyst symbol, a payout is awarded based upon values on any value-bearing symbols among the landed symbols.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is a flowchart for a data processing method that corresponds to instructions executed by a controller, according to an embodiment of the present invention.

FIGS. 4-7 are exemplary representations of game images according to an embodiment of the present invention.

FIG. 8 is a reel strip diagram according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a. player places at risk a sum of money or other representation of value, whether or not redeemable for cash, on an event with an uncertain outcome, including without limitation those having some element of skill. In some embodiments, the wagering game involves wagers of real money, as found with typical land-based. or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

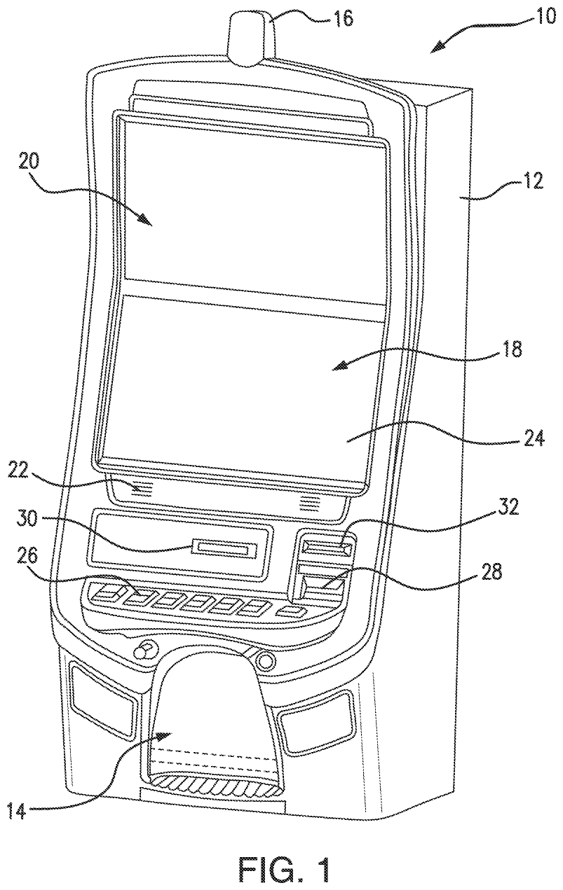

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaining machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, entails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

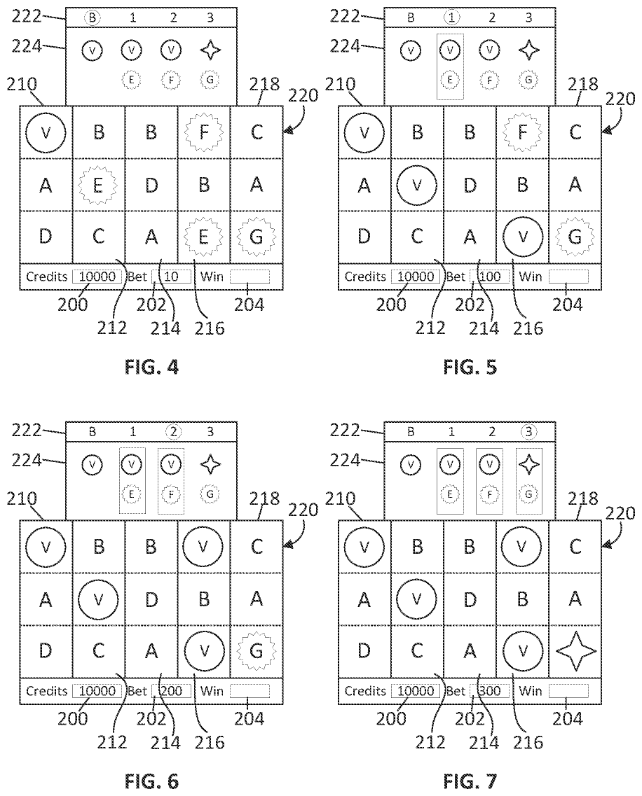

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIGS. 4-7). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIGS. 4-7), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

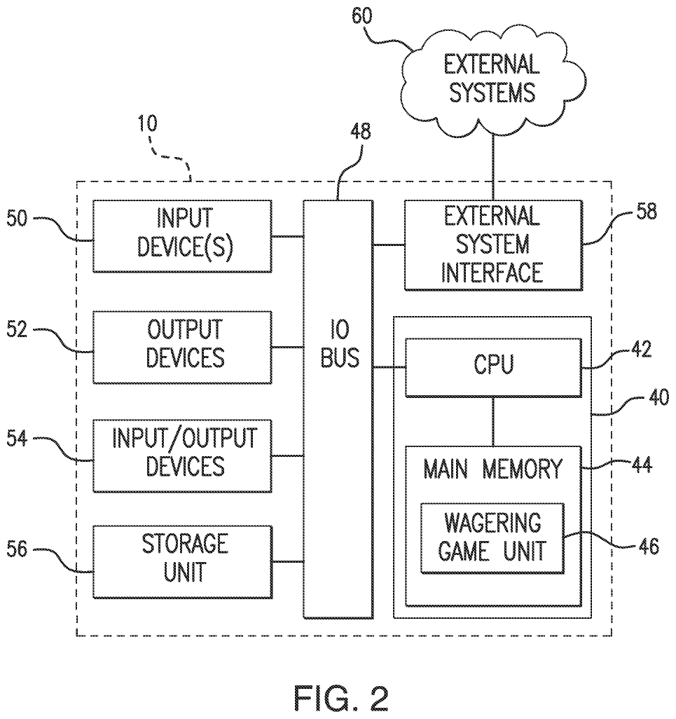

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices, The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a. near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40 whether located within (“thick client”), external to (“thin client”), or distributed both within and external to (“intermediate client”) the gaming machine 10 is utilized to provide a wagering game on the gaming machine 10. In general, the main memory 44 stores programming for a random number generator (RNG), game-outcome logic, and game assets (e.g., art, sound, etc.—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10. external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RING or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.), For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

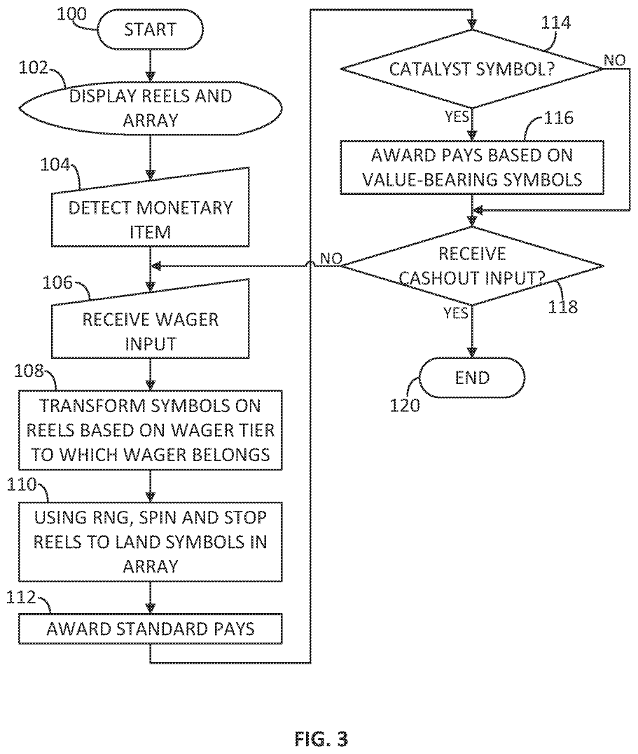

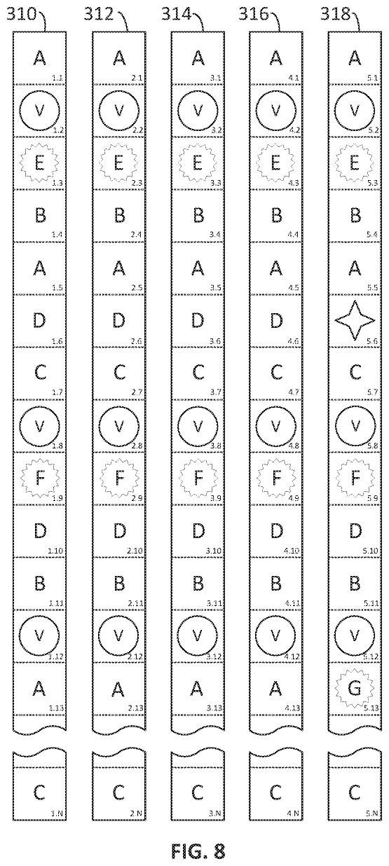

Referring now to FIG. 3, there is shown a flowchart representing one data processing method corresponding to at least some instructions stored and executed by the game-logic circuitry 40 in FIG. 2 to perform operations according to an embodiment of the present invention. The data processing method is described below in connection with the exemplary representations of game images in FIGS. 4-7 and a reel strip diagram in FIG. 8.

The data processing method commences at step 100. At step 102, the game-logic circuitry directs an electronic display device (e.g., video display) of the gaming machine to display a plurality of symbol-bearing reels and an array of symbol positions. The symbol positions of the array may be arranged in a variety of configurations, formats, or structures and may comprise a plurality of rows and columns. The rows of the array are oriented in a horizontal direction, and the columns of the array are oriented in a generally vertical direction. The symbol positions in each row of the array are horizontally aligned with each other, and the symbol positions in each column of the array are vertically aligned with each other. The number of symbol positions in different rows and/or different columns may vary from each other. The reels may be associated with the respective columns of the array such that the reels spin vertically and each reel populates a respective column. In another embodiment, the reels may be associated with the respective rows of the array such that the reels spin horizontally and each reel populates a respective row. In yet another embodiment, the reels may be associated with respective individual symbol positions of the array such that each reel populates only its respective symbol position.

In the example shown in FIGS. 4-7, the electronic display device displays five reels 210, 212, 214, 216, 218 and an array 220. The reels 210, 212, 214, 216, 218 support respective electronic reel strips such as the reel strips 310, 312, 314, 316, 318 shown in FIG. 8. The reel strips bear a plurality of symbols. Each reel strip may, for example, bear symbols at N symbol positions. Specifically, reel strip 310 includes positions labeled 1.1 through 1.N; reel strip 312 includes positions labeled 2.1 through 2.N; reel strip 314 includes positions labeled 3.1 through 3.N; reel strip 316 includes positions labeled 4.1 through 4.N; and reel strip 318 includes positions labeled 5.1 through 5.N. The plurality of symbols may, for example, include (i) standard symbols A, B, C, and D; (ii) transformable symbols E, F, and. G; (iii) value-bearing symbols V; and (iv) a catalyst symbol in the form of a four-pointed star (e.g., position 5.6 of reel strip 318). Each value-bearing symbol V is associated with a credit or currency value indicated on the symbol itself. The value on a particular symbol V may be fixed or variable (e.g., random) from one game cycle to the next. Different value-bearing symbols V on the reel strips may have different values. The catalyst symbol may appear only on the reel strip 318 of the rightmost reel 218. The number of symbol positions on each reel strip and the arrangement of symbols along the reel strip may vary from that shown in FIG. 8. And the reel strips may vary from each other in terms of number of symbol positions, arrangement of symbols, and which symbols exist on the reel strip.

Returning to FIG. 3, at step 104, the game-logic circuitry detects, via at least one of one or more electronic input devices, a physical item associated with a monetary value that establishes a credit balance. As shown in FIGS. 4-7, for example, the credit balance may be shown on a credit meter 200 of the gaming machine.

At step 106, the game-logic circuitry initiates a wagering game cycle in response to an input indicative of a wager covered by the credit balance. To initiate a spin of the reels, the player may press a “Spin” or “Max Bet” key on a button panel or touch screen.

Referring to FIGS. 4-7, the wager is shown on a bet meter 202 and belongs to one of a plurality of wager tiers shown on a wager tier indicator 222. The plurality of wager tiers may include a base tier B, a first tier (1), a second tier (2), and a third tier (3). As shown in FIG. 4, the base tier applies to any wager below 100 credits and is not associated with any transformable symbols, i.e., does not cause any symbol transformations as discussed below. As shown in FIG. 5, the first wager tier (1) starts at a wager of 100 credits and is associated with the transformable symbols E. As shown in FIG. 6, the second wager tier (2) starts at a wager of 200 credits and is associated with the transformable symbols E and F. As shown in FIG. 7, the third wager tier (3) starts at a wager of 300 credits and is associated with the transformable symbols E, F, and G. In another embodiment, the base tier applies to any wager below 100 credits and is not associated with any transformable symbols, i.e., does not cause any symbol transformations as discussed below; the first wager tier (1) starts at a wager of 100 credits and is associated with the transformable symbols E; the second wager tier (2) starts at a wager of 200 credits and is associated with the transformable symbols F but not E; and the third wager tier (3) starts at a wager of 300 credits and is associated with the transformable symbols G but not E or F.

Returning to FIG. 3. at step 108, based on the wager tier to which the wager belongs, the game-logic circuitry may transform one or more of the symbols in the plurality of symbols on the reels.

FIGS. 4-7 depict the symbol transformations that occur at different wager tiers prior to spinning and stopping the reels, or at least prior to stopping the reels. These figures also depict a symbol transformation indicator 224 indicating which symbols will be transformed, and what they will be transformed to, based on the wager tier to which the wager belongs, Specifically, in response to the wager belonging to the base tier B as shown by the tier indicator 222 in FIG. 4, the transformation indicator 224 shows that none of the transformable symbols E, F, or G are transformed, In response to the wager belonging to the first tier (1) as shown by the tier indicator 222 in FIG. 5, the transformation indicator 224 shows that the symbols E are transformed into value-bearing symbols V. Comparing FIGS. 4 and 5, it can be seen that the symbols E in FIG. 4 are transformed into the value-bearing symbols V in FIG. 5. In response to the wager belonging to the second tier (2) as shown by the tier indicator 222 in FIG. 6, the transformation indicator 224 shows that the symbols E and F are transformed into value-bearing symbols V. Comparing FIGS. 4 and 6, it can be seen that the symbols E and F in FIG. 4 are transformed into the value-bearing symbols V in FIG. 6, In response to the wager belonging to the third tier (3) as shown by the tier indicator 222 in FIG. 7, the transformation indicator 224 shows that the symbols E and F are transformed into value-bearing symbols V, and the symbols G are transformed into the catalyst symbol (e.g., four-pointed star). Comparing FIGS. 4 and 7, it can be seen that the symbols E and F in FIG. 4 are transformed into the value-bearing symbols V in FIG. 7, and that the symbol G in FIG. 4 is transformed into the catalyst symbol in FIG. 7.

In another embodiment, in response to the wager belonging to the second tier (2), only the symbols F are transformed into value-bearing symbols while the symbols E are not transformed. And in response to the wager belonging to the third tier (3), the symbols G are transformed into the catalyst symbol while the symbols E and F are not transformed,

When the player selects their wager, the electronic display device animates a number of elements on the game screen. For example, the wager tier indicator 222 applies a border, pattern, color change, background change, watermark, or other distinguishing characteristic to the wager tier B, 1, 2, or 3 to which the wager belongs. In addition, the symbol transformation indicator 224 applies a border, pattern, color change, background change, watermark, or other distinguishing characteristic to the symbols that are subject to transformation based on the wager tier to which the wager belongs and, additionally, shows the symbols that will result from the transformation. Furthermore, at the time the player places a wager, the array contains an outcome of the immediately preceding base game cycle, i.e., the symbols that landed in the array as a result of the preceding reel spin. To the extent any of those symbols (that landed in the preceding spin) will be transformed based on the wager tier to which the wager belongs, the display may animate such transformation by morphing a symbol from a non-transformed state to a transformed state,

Returning to FIG. 3, at step 110, using an RNG, the game-logic circuitry spins and stops the reels to randomly land symbols from the reels in the array in visual association with one or more paylines (also known as lines, ways, patterns, or arrangements). The reel spin is animated by depicting symbol-bearing strips moving vertically across the display and synchronously updating the symbols visible on each strip as the strip moves across the display. At step 112, the game-logic circuitry awards standard pays in accordance with a pay table. The pay table may, for example, include “line pays” and “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. The awarded pays are added to a win meter such as meter 204 in FIGS. 4-7.

At step 114, the game-logic circuitry determines whether or not a catalyst symbol landed in the array. If a catalyst symbol did not land in the array, the game-logic circuitry immediately proceeds to step HS. If, however, a catalyst symbol landed in the array, the game-logic circuitry proceeds to step 116 where it awards pays based on any value-bearing symbols in the array. By way of example, if the spin generates the array of symbols shown in FIG. 7 (which includes the catalyst symbol, e.g., four-pointed star, on reel 218), the game-logic circuitry would award the sum of the values on the four value-bearing symbols V. The awarded pays are added to the win meter 204. The game-logic circuitry then proceeds to step 118.

At step 118, the game-logic circuitry determines whether or not it has received a cashout input via at least one of the one or more player input devices of the gaming machine. If it has not received a cashout input, the game-logic circuitry waits for the next wager input at step 106. If it has received a cashout input, the game-logic circuitry initiates a payout from the credit balance on the credit meter such as the meter 200 in FIGS. 4-7. The data processing method then ends at step 120.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
displaying, on an electronic display device, a plurality of reels and an array, the plurality of reels bearing a plurality of symbols, the plurality of symbols including first symbols, second symbols, third symbols, and catalyst symbols;
receiving, via at least one of one or more electronic input devices, an input indicative of a. wager, the wager belonging to one of a plurality of wager tiers, the plurality of wager tiers including a first wager tier, a second wager tier, and a third wager tier, the first wager tier being associated with the first symbols, the second wager tier being associated with the first symbols and the second symbols, the third wager tier being associated with the first symbols, the second symbols, and the third symbols;
transforming, by game-logic circuitry, one or more of the symbols in the plurality of symbols based on the one of the plurality of wager tiers to which the wager belongs,
wherein in response to the wager belonging to the first tier, transforming the first symbols into value-bearing symbols;
wherein in response to the wager belonging to the second tier, transforming the first symbols and the second symbols into value-bearing symbols; and
wherein in response to the wager belonging to the third tier, transforming the first symbols and the second symbols into value-bearing symbols and. transforming the third symbols into the catalyst symbols;
spinning and stopping the plurality of reels to land symbols from the plurality of symbols in the array, the transforming operation occurring before the reels are stopped; and
awarding, by the game-logic circuitry, a payout based on the landed symbols, wherein in response to the landed symbols including one of the catalyst symbols, the payout is based at least partly on values on any value-bearing symbols among the landed symbols.

2. The method of claim 1, wherein the catalyst symbols appear only on a rightmost one of the plurality of reels.

3. The method of claim 1, wherein the plurality of wager tiers include a base tier below the first tier, and wherein the transforming operation includes transforming none of the plurality of symbols in response to the wager belonging to the base tier,

4. The method of claim 1, wherein the transforming operation occurs before the spinning and stopping operation.

5. The method of claim 1, wherein each reel is associated with a respective column of the array.

6. The method of claim 1, wherein the value-bearing symbols transformed from the second symbols have a higher value, on average, than the value-bearing symbols transformed. from the first symbols.

7. The method of claim 1, further comprising:
detecting, via at least one of the one or more electronic input devices, a physical item associated with a monetary value that establishes a credit balance; and
receiving, via at least one of the one or more electronic input devices, a cashout input that initiates a payout from the credit balance.

8. A method of operating a gaming machine, the method comprising the operations of:
displaying, on an electronic display device, a plurality of reels and an array, the plurality of reels bearing a plurality of symbols, the plurality of symbols including first symbols, second symbols, third symbols, and catalyst symbols;
receiving, via at least one of one or more electronic input devices, an input indicative of a. wager, the wager belonging to one of a plurality of wager tiers, the plurality of wager tiers including a first wager tier, a second wager tier, and a third wager tier, the first wager tier being associated with the first symbols, the second wager tier being associated with the second symbols, the third wager tier being associated with the third symbols;
transforming, by game-logic circuitry, one or more of the symbols in the plurality of symbols based on the one of the plurality of wager tiers to which the wager belongs,
wherein in response to the wager belonging to the first tier, transforming the first symbols into value-bearing symbols;
wherein in response to the wager belonging to the second tier, transforming the second symbols into value-bearing symbols; and
wherein in response to the wager belonging to the third tier, transforming the third symbols into the catalyst symbols;
spinning and stopping the plurality of reels to land symbols from the plurality of symbols in the array, the transforming operation occurring before the reels are stopped; and
awarding, by the game-logic circuitry, a payout based on the landed symbols, wherein in response to the landed symbols including one of the catalyst symbols, the payout is based at least partly on values on any value-bearing symbols among the landed symbols.

9. The method of claim 8, wherein the catalyst symbols appear only on a rightmost one of the plurality of reels.

10. The method of claim 8, wherein the plurality of wager tiers include a base tier below the first tier, and wherein the transforming operation includes transforming none of the plurality of symbols in response to the wager belonging to the base tier.

11. The method of claim 8, wherein the transforming operation occurs before the spinning and stopping operation.

12. The method of claim 8, wherein each reel is associated with a respective column of the array.

13. The method of claim 8, wherein the value-bearing symbols transformed from the second symbols have a higher value, on average, than the value-bearing symbols transformed from the first symbols.

14. The method of claim 8, further comprising:
detecting, via at least one of the one or more electronic input devices, a physical item associated with a monetary value that establishes a credit balance; and
receiving, via at least one of the one or more electronic input devices, a cashout input that initiates a payout from the credit balance.

15. A gaming system comprising:
a gaming machine including an electronic display device configured to display a plurality of reels and an array, the plurality of reels bearing a plurality of symbols, the plurality of symbols including first symbols, second symbols, third symbols, and catalyst symbols; and
game-logic circuitry configured to perform the operations of:
receiving, via at least one of one or more electronic input devices, an input indicative of a wager, the wager belonging to one of a plurality of wager tiers, the plurality of wager tiers including a first wager tier, a second wager tier, and a third wager tier, the first wager tier being associated with the first symbols, the second wager tier being associated with the first symbols and the second symbols, the third wager tier being associated with the first symbols, the second symbols, and the third symbols;
transforming one or more of the symbols in the plurality of symbols based on the one of the plurality of wager tiers to which the wager belongs,
wherein in response to the wager belonging to the first tier, transforming the first symbols into value-bearing symbols;
wherein in response to the wager belonging to the second tier, transforming the second symbols into value-bearing symbols; and
wherein in response to the wager belonging to the third tier, transforming the third symbols into the catalyst symbols;
spinning and stopping the plurality of reels to land symbols from the plurality of symbols in the array, the transforming operation occurring before the reels are stopped; and
awarding a payout based on the landed symbols, wherein in response to the landed symbols including one of the catalyst symbols, the payout is based at least partly on values on any value-bearing symbols among the landed symbols.

16. The gaming system of claim 15, wherein the transforming operation includes:
wherein in response to the wager belonging to the second tier, transforming the first symbols into value-bearing symbols; and
wherein in response to the wager belonging to the third tier, transforming the first symbols and the second symbols into value-bearing symbols

17. The gaming system of claim 15, wherein the plurality of wager tiers include a base tier below the first tier, and wherein the transforming operation includes transforming none of the plurality of symbols in response to the wager belonging to the base tier.

18. The gaming system of claim 15, wherein the transforming operation occurs before the spinning and stopping operation.

19. The gaming system of claim 15, wherein the value-bearing symbols transformed from the second symbols have a higher value, on average, than the value-bearing symbols transformed from the first symbols.

20. The gaming system of claim 15, wherein the game-logic circuitry is configured to perform the operations:
detecting, via at least one of the one or more electronic input devices, a physical item associated with a monetary value that establishes a credit balance; and
receiving, via at least one of the one or more electronic input devices, a cashout input that initiates a payout from the credit balance.
